(19) United States
(12) Patent Application Publication
(10) Pub. No.: US 2014/0185126 A1
(43) Pub. Date: Jul. 3, 2014

(54) ELECTROWETTING CELLS AND DRIVING METHODS THEREFOR

(71) Applicant: DELTA ELECTRONICS, INC, Taoyuan Hsien (TW)

(72) Inventors: Rong-Chang LIANG, Taoyuan Hsien (TW); Ching-Tung HSU, Taoyuan Hsien (TW); Yeong-Feng WANG, Taoyuan Hsien (TW); Ming-Wei TSAI, Taoyuan Hsien (TW); Chia-Yen LEE, Taoyuan Hsien (TW); Meng-Han LIU, Taoyuan Hsien (TW); Yen-I CHOU, Taoyuan Hsien (TW)

(73) Assignee: DELTA ELECTRONICS, INC, Taoyuan Hsien (TW)

(21) Appl. No.: 13/728,665

(22) Filed: Dec. 27, 2012

(51) Int. Cl. G02B 26/00

(52) U.S. Cl. CPC G02B 26/005
USPC 359/290

(57) ABSTRACT

An electrowetting cell includes first and second substrates, a spacer, first and second electrodes, a dielectric layer, and a medium. The spacer is disposed between the first and second substrates to substrate define a compartment. The first and second electrodes are disposed on the first and second substrates respectively. The dielectric layer is formed on the first electrode. The medium is filled in the compartment and deformed in accordance with an electric potential difference between the first and second electrodes. One of the first and second electrodes is applied by a driving signal. The driving signal is divided into a plurality of driving sections in a first time period. A first driving section is changed between first and second threshold voltage levels, and a horizontal voltage level is inserted into the first driving section.

### BACKGROUND OF THE INVENTION

1. Field of the Invention

The invention relates to an electrowetting cell, and more particularly to an electrowetting cell for 3D display and a method for driving the electrowetting cell.

2. Description of the Related Art

Generally, an electrowetting cell comprises at lease two electrodes, a dielectric layer formed on one of the two electrodes, and a medium, such as a fluid, filled between the dielectric layer and the other of the two electrodes. By changing a voltage difference between the two electrodes, the fluid is deformed. Through deformation of the fluid, a deflection angle of a light beam entering the electrowetting cell is changed. Thus, electrowetting cells may be applied to a three-dimensional (3D) image displayer capable of showing stereoscopic images or animations. Due to a change in a deflection angle of a light beam entering an electrowetting cell, right eye images are deflected to a right eye of a viewer, and left eye images are deflected to a left eye of the viewer, respectively, so that the viewer may view 3D images.

FIG. 1 shows an example of a conventional driving signal applied to at least one electrode of an electrowetting cell. A driving signal S10 is switches between an upper threshold voltage level VTH10 and a lower threshold voltage VTH11. It is assumed the difference between the upper threshold voltage level VTH10 and the lower threshold voltage VTH11 is equal to one unit voltage (V). In a time period P11, the driving signal S10 is switched to the lower threshold voltage level VTH11, and a fluid filled between an electrode and a dielectric layer in the electrowetting cell is in an initial form. In a time period P10, the driving signal S10 is switched to the upper threshold voltage level VTH10, and the fluid is deformed. However, when the driving signal S10 has be switched between the upper threshold voltage level VTH10 and the lower threshold voltage VTH11 many times, the quantity of the deformation of the fluid is not the equal each time when the driving signal S10 is switched. If the electrodewetting cell applied by the driving signal S10 is used in a 3D image displayer, a change in a deflection angle of an incoming light beam is different with working time of the 3D image displayer.

FIG. 2 shows another example of a conventional driving signal applied to at least one electrode of an electrowetting cell. In the time period P21, the driving signal S20 is continuously at a voltage level VL20, and a fluid filled between an electrode and a dielectric layer in the electrowetting cell is in an initial form. In a time period P20, the driving signal S20 is continuously switched to an upper threshold voltage level VTH20 and a lower threshold voltage level VTH21, and the fluid is deformed. Due to the switching of the driving signal S20 in the time period P20, polarities of charges in the fluid are neutralized, and there is no remaining charge in the fluid. However, in this driving manner, the difference between the upper threshold voltage level VTH20 and the lower threshold voltage VTH21 becomes to two unit voltages (2V). Thus, the dielectric layer will be damaged due to the larger voltage difference, resulting in decreasing lift time of the electrowetting cell.

Thus, it is desired to provide a driving signal for an electrowetting cell, which is capable of keeping quantity of deformation of a medium filled in the electrowetting cell and preventing a dielectric layer in the electrowetting cell from being damaged.

### BRIEF SUMMARY OF THE INVENTION

An exemplary embodiment of an electrowetting cell is provided. The electrowetting cell comprises a first substrate, a spacer, a second substrate, a first electrode, a second electrode, a dielectric layer, and a medium. The spacer is disposed on the first substrate. The second substrate is disposed on the spacer and opposite to the first substrate. The first substrate, the second substrate and the spacer define a compartment. The first electrode is disposed on the first substrate. The second electrode is disposed on the second substrate. The dielectric layer is formed on the first electrode. The medium is filled in the compartment and deformed in accordance with an electric potential difference between the first and second electrodes. One of the first and second electrodes is applied by a driving signal. The driving signal is generates in a first time period and a second time period. The driving signal is divided into a plurality of driving sections in the first time period. A first driving section among the plurality of driving sections is changed between a first threshold voltage level and a second threshold voltage level, and a first horizontal voltage level between the first and second threshold voltage levels is inserted into the first driving section.

An exemplary embodiment of a driving method for an electrowetting cell is provided. The electrowetting cell comprises a first substrate, a spacer disposed on the first substrate, a second substrate disposed on the spacer and opposite to the first substrate, a first electrode disposed on the first substrate, a second electrode disposed on the second substrate, a dielectric layer formed on the first electrode, and a medium filled in a compartment defined by the first substrate, the second substrate and the spacer. The driving method comprises the step of providing a driving signal in a first time period and a second time period. The driving signal comprises a plurality of driving sections. The driving method further comprises step of applying the driving signal to one of the first and second electrode to deform the medium. A first driving section among the plurality of driving sections is changed between a first threshold voltage level and a second threshold voltage level. A first horizontal voltage level between the first and second threshold voltage levels is inserted into the first driving section.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an example of a conventional driving signal applied to at least one electrode of an electrowetting cell;

FIG. 2 shows another example of a conventional driving signal applied to at least one electrode of an electrowetting cell;

FIG. 3 shows an exemplary embodiment of an electrowetting cell;

FIGS. 4A and 4B show an exemplary embodiment of a waveform of a driving signal applied to the electrowetting cell of FIG. 3;

FIG. 5 shows another exemplary embodiment of a waveform of a driving signal applied to the electrowetting cell of FIG. 3;

FIGS. 6A-6C show further another exemplary embodiment of a waveform of a driving signal applied to the electrowetting cell of FIG. 3;

FIG. 7 shows an exemplary embodiment of a waveform of a driving signal applied to the electrowetting cell of FIG. 3;

FIG. 8 shows another exemplary embodiment of a waveform of a driving signal applied to the electrowetting cell of FIG. 3;

FIG. 9 shows further another exemplary embodiment of a waveform of a driving signal applied to the electrowetting cell of FIG. 3;

FIGS. 10A and 10B show exemplary embodiments of a waveform of a driving signal applied to the electrowetting cell of FIG. 3;

FIG. 11 shows another exemplary embodiments of a waveform of a driving signal applied to the electrowetting cell of FIG. 3;

FIG. 12 shows an exemplary embodiment of a 3D display system; and

FIG. 13 shows another exemplary embodiment of an electrowetting cell.

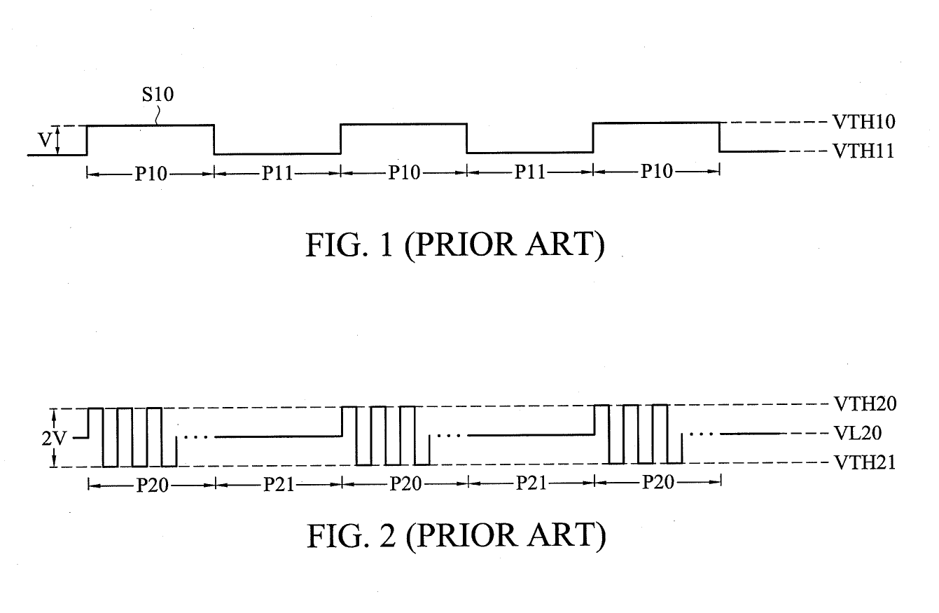

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

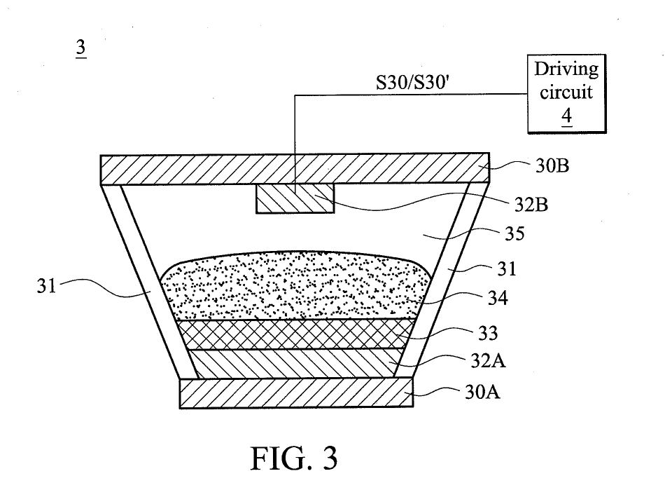

Electrowetting cells are provided. In an exemplary embodiment of an electrowetting cell in FIG. 3, an electrowetting cell 3 includes a substrate 30A, an opposite substrate 30B, spacers 31, a bottom electrode 32A, a top electrode 32B, and a dielectric layer 33. The spacers 31 are disposed on the substrate 7B, and the opposite substrate 30B is disposed on the spacer 31. The substrate 30A, the spacers 31, and the opposite substrate 30B define a compartment. The bottom electrode 32A is disposed on the substrate 30A. The dielectric layer 33 is formed on the bottom electrode 32A. The top electrode 32B is on the surface of the opposite substrate 30B which faces the substrate 30A. A medium 34 and a medium 35 are filled into the compartment, and the medium 34 and the medium 35 are incompatible. The medium 34 is hydrophilic, such as water, saline, and the like. The medium 35 is hydrophobic, such as silicone oil, mixture of silicone oil and tetrabromo methane, mineral oil, and hexadecane. In other embodiments, air may replace the medium 35. In the embodiment of FIG. 3, the medium 34 is implemented by water, and the medium 35 is implemented by air.

In the electrowetting cell 3, one of the bottom electrode 32A and the top electrode 32B is applied by a driving signal S30 generated by a driving device 4. In accordance with electric potential difference between the bottom electrode 32A and the top electrode 32B, the medium 34 is deformed, that is the curvature ratio of the interface between the medium 34 and the medium 35 is changed. Through deformation of the medium 34, deflection angles of light beams entering the electrowetting cell 3 are changed. In the embodiment of FIG. 3, the top-electrode 32B is applied by the driving signal S30, while the bottom electrode 32A is applied by a fixed voltage, such as ground voltage. The fixed voltage may be provided from the driving device 4.

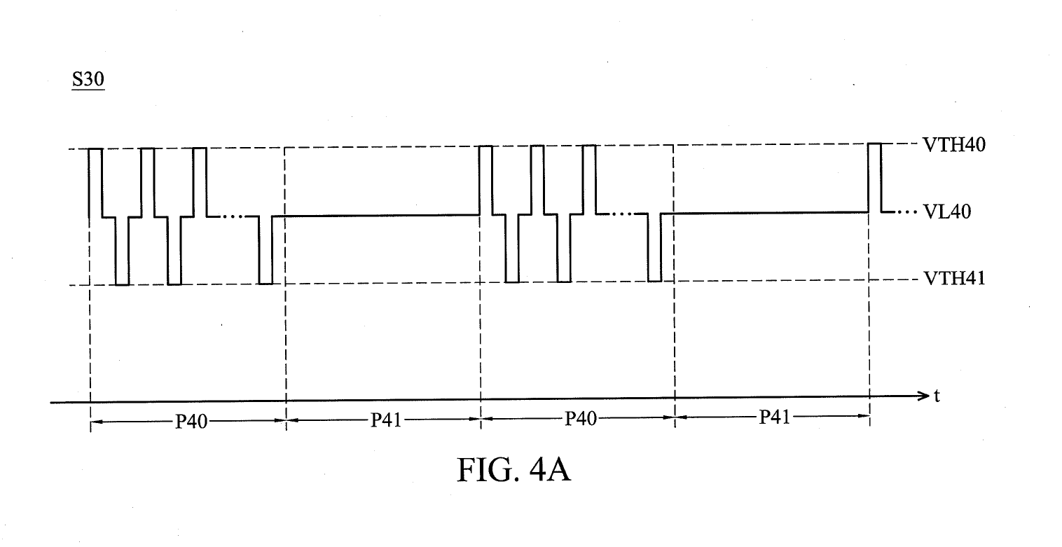

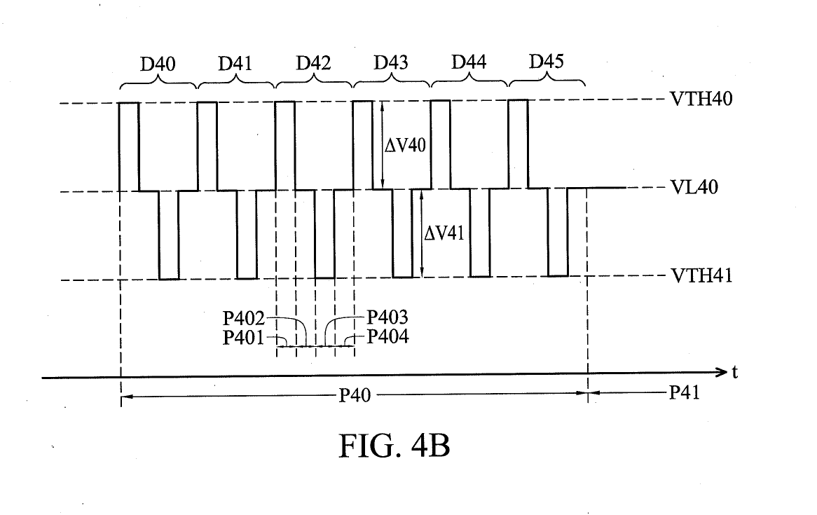

FIG. 4A shows an exemplary embodiment of the driving signal S30. As shown in FIG. 4A, the driving signal S30 is generates in interlaced time periods P40 and P41. In the embodiment of FIG. 4A, two time periods P40 and two time periods P41 are given as an example. In each time period P41, the driving signal S30 is continuously at a horizontal voltage level VL40. In each time period P40, the driving signal S30 is divided into a plurality of driving sections along the time axis, as shown in FIG. 4B. For clear description, FIG. 4B shows the driving signal S30 in only one time period P40. For example, the driving signal S30 is divided into six driving sections D40˜D45. The driving sections D40˜D45 occur successively. In the following, the driving section D42 of the driving signal S30 is given as an example for explaining the waveform of the driving signal S30 in each time period P40. The other driving sections D40˜D41 and D43˜D45 in each time period P40 have the same waveform as the driving section D42.

Referring to FIG. 4B, the driving signal S30 is changed between an upper threshold voltage level VTH40 and a lower threshold voltage level VTH41 in each time period P40. During the inversion period when the driving section D42 is inverted from the upper threshold voltage level VTH40 to the lower threshold voltage level VTH41, a horizontal voltage level between the upper threshold voltage level VTH40 and the lower threshold voltage level VTH41 is inserted into the driving section D42. Similarly, during the inversion period when the driving section D42 is inverted from the lower threshold voltage level VTH41 to the upper threshold voltage level VTH40, a horizontal voltage level between the upper threshold voltage level VTH40 and the lower threshold voltage level VTH41 is inserted into the driving section D42. In the embodiment of FIGS. 4A and 4B, the horizontal voltage levels which are inserted into the driving section D42 during the above two inversion periods are the same.

Referring to FIG. 4B, in detailed, in a time period P401, the driving section D42 is at the upper threshold voltage level VTH40. In a time period P402 later than the time period P401, the driving section D42 is switched to be at the horizontal voltage level VL40, that the horizontal voltage level VL40 is inserted into the driving section D42. In a time period P403 later than the time period P402, the driving section D42 is switched to be at the lower threshold voltage level VTH41. Further, in a time period P404 later than the time period P403, the driving section D42 is switched to be at the horizontal voltage level VL40. Due to the horizontal voltage level VL40 during the two inversion periods, the dielectric layer 33 may not suffer larger voltage variation in a short time period, thereby preventing the dielectric layer 33 from being damaged and increasing the lift time of the electrowetting cell 3.

In the embodiment of FIGS. 4A and 4B, the horizontal voltage levels which are inserted into the driving section D42 during the above inversion periods are the same. The horizontal voltage level VL40 is an average voltage level between the upper threshold voltage level VTH40 and the lower threshold voltage level VTH41. In other words, the difference ΔV40 between the upper threshold voltage level VTH40 and the horizontal voltage level VL40 is equal to the difference ΔV41 between the horizontal voltage level VL40 and the lower threshold voltage level VTH41. In another embodiment, the horizontal voltage levels which are inserted into the driving section D42 during the above inversion periods are different. In a preferred embodiment, the lengths of the periods P401-P404 are equal.

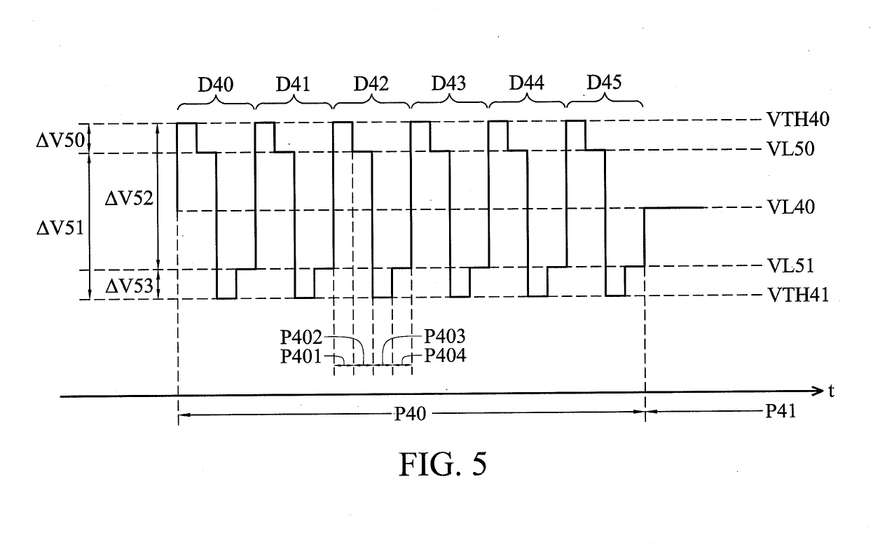

As shown in FIG. 5, during the inversion period when the driving section D42 is inverted from the upper threshold voltage level VTH40 to the lower threshold voltage level VTH41, a horizontal voltage level VL50 between the upper threshold voltage level VTH40 and the lower threshold voltage level VTH41 is inserted into the driving section D42. Similarly, during the inversion period when the driving section D42 is inverted from the lower threshold voltage level VTH41 to the upper threshold voltage level VTH40, another horizontal voltage level VL51 between the upper threshold voltage level VTH40 and the lower threshold voltage level VTH41 is inserted into the driving section D42. In the embodiment of FIG. 5, the difference ΔV50 between the upper threshold voltage level VTH40 and the horizontal voltage level VL50 is less than the difference ΔV51 between the horizontal voltage level VL50 and the lower threshold voltage level VTH41. The difference ΔV52 between the upper threshold voltage level VTH40 and the horizontal voltage level VL51 is larger than the different ΔV53 between the horizontal voltage level VL51 and the lower threshold voltage level VTH41. In a preferred embodiment, the difference ΔV50 is equal to the different ΔV53, that is the difference ΔV51 is equal to the difference ΔV52.

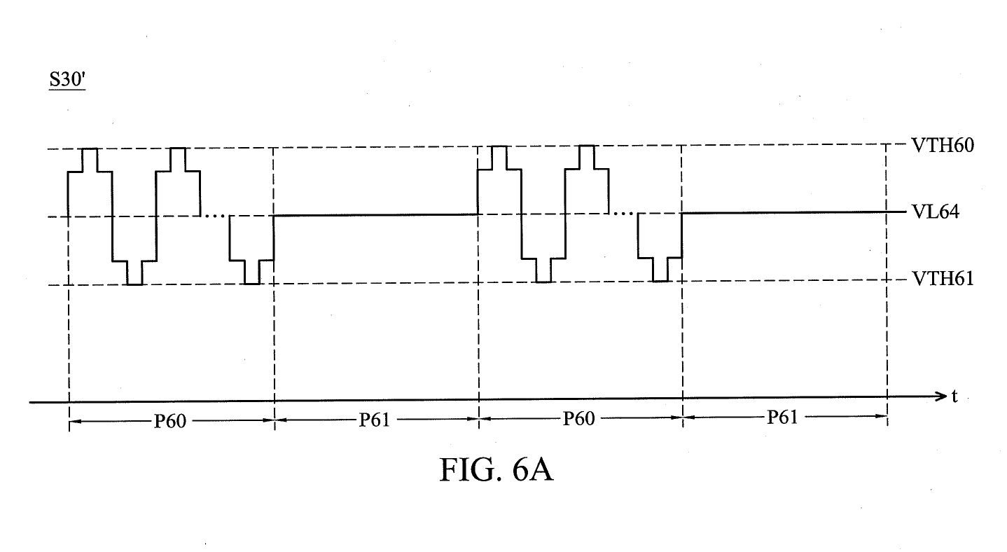

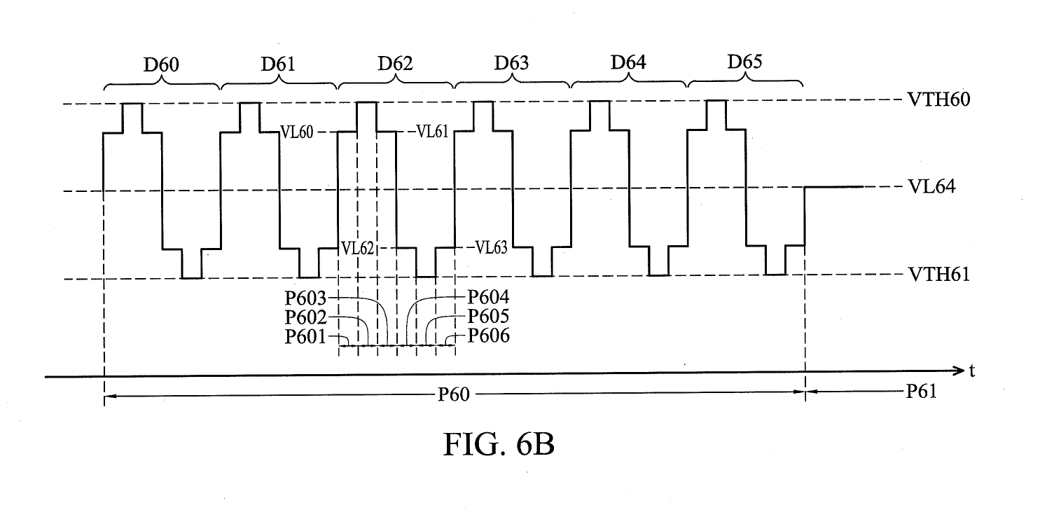

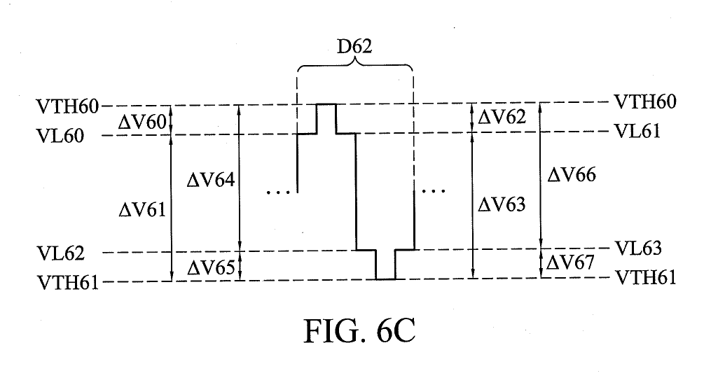

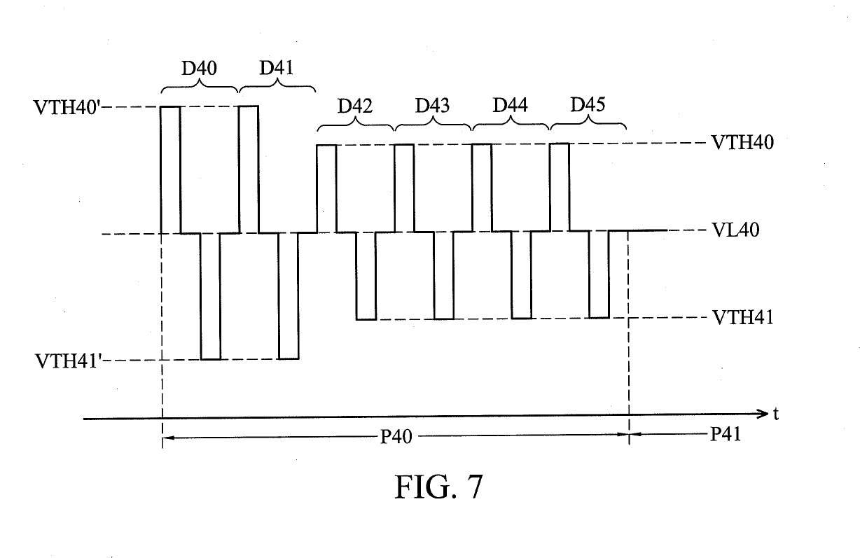

In other embodiments, the top electrode 32B may be applied by a driving signal S30′ generated by the driving device 4. As shown in FIG. 6A, the driving signal S30′ is generates in interlaced time periods P60 and P61. In the embodiment of FIG. 6A, two time periods P60 and two time periods P61 are given as an example. In each time period P61, the driving signal S30′ is continuously at a horizontal voltage level VL64. In each time period P60, the driving signal S30′is divided into a plurality of driving sections along the time axis, as shown in FIG. 6B. For clear description, FIG. 6B shows the driving signal S30′ in only one time period P60. For example, the driving signal S30′ is divided into six driving sections D60˜D65. The driving sections D60˜D65 occur successively. In the following, the driving section D62 of the driving signal S30′ is given as an example for explaining the waveform of the driving signal S30′ in each time period P60. The other driving sections D60˜D61 and D63˜D65 in each time period P60 have the same waveform as the driving section D62.

Referring to FIG. 6B, the driving section D62 is changed between an upper threshold voltage level VTH60 and a lower threshold voltage level VTH61 in each time period P60. Before and after the driving section D62 reaches the upper threshold voltage level VTH60, two horizontal voltage levels between the upper threshold voltage level VTH60 and the lower threshold voltage level VTH61 are inserted into the driving section D62, respectively. Similarly, before and after the driving section D62 reaches the lower threshold voltage level VTH61, two horizontal voltage levels between the upper threshold voltage level VTH60 and the lower threshold voltage level VTH61 are inserted into the driving section D62, respectively.

Referring to FIG. 6B, in detailed, in a time period P601, the driving section D62 is at a horizontal voltage level VL60, that the horizontal voltage level VL60 is inserted into the driving section D62. In a time period P602 later than the time period P601, the driving section D62 increases to be at upper threshold voltage level VTH60. In a time period P603 later than the time period P602, the driving section D62 decreases to be at a horizontal voltage level VL61. Then, in a time period P604 later than the time period P603, the driving section D62 further decreases to be at a horizontal voltage level VL62. In a time period P605 later than the time period P604, the driving section D62 decreases to be at the lower threshold voltage level VTH41. Further, in a time period P606 later than the time period P605, the driving section D62 increases to be at a horizontal voltage level VL63. Due to the inserted horizontal voltage levels VL60˜VL63, the dielectric layer 33 may not suffer larger voltage variation in a short time period, thereby preventing the dielectric layer 33 from being damaged and increasing the lift time of the electrowetting cell 3. In a preferred embodiment, the lengths of the periods P601-P606 are equal.

In the embodiment of FIGS. 6A and 6B, each of the horizontal voltage level VL60˜VL63 is between the upper threshold voltage level VTH60 and the lower threshold voltage level VTH61. As shown in FIG. 6C, the difference ΔV60 between the upper threshold voltage level VTH60 and the horizontal voltage level VL60 is less than the difference ΔV61 between the horizontal voltage level VL60 and the lower threshold voltage level VTH61. The difference ΔV62 between the upper threshold voltage level VTH60 and the horizontal voltage level VL61 is less than the different ΔV63 between the horizontal voltage level VL61 and the lower threshold voltage level VTH61. The difference ΔV64 between the threshold voltage level VTH60 and the horizontal voltage level VL62 is larger than the difference ΔV65 between the horizontal voltage level VL62 and the lower threshold voltage level VTH61. The difference ΔV66 between the upper threshold voltage level VTH60 and the horizontal voltage level VL63 is larger than the different ΔV67 between the horizontal voltage level VL63 and the lower threshold voltage level VTH61. In a preferred embodiment, the difference ΔV60 is equal to the difference ΔV65, while the difference ΔV62 is equal to the difference ΔV67. In another preferred embodiment, the differences ΔV60, ΔV62, ΔV65, ΔV67 are equal.

According to the above embodiments of FIGS. 4A-4B and 5A-5B, in each time period P40 of the driving signal S30, each of the six driving sections D40˜D45 are changed between the upper threshold voltage level VTH40 and the lower threshold voltage level VTH41. In other embodiments, for over-driving, among the six driving sections D40˜D45 in each time period P40, at lease one earliest driving section is changed between an upper threshold voltage level VTH40′ and a lower threshold voltage level VTH41′. The difference between the upper threshold voltage level VTH40′ and the lower threshold voltage level VTH41′ is larger than the difference between the upper threshold voltage level VTH40 and the lower threshold voltage level VTH41, as shown in FIG. 7. In a preferred embodiment, the upper threshold voltage level VTH40′ is further higher than the upper threshold voltage level VTH40, while the lower threshold voltage level VTH41′ is further lower than the lower threshold voltage level VTH40. For example, as shown in FIG. 7, the driving sections D40 and D41 are changed between the upper threshold voltage level VTH40′ and the lower threshold voltage level VTH40′, and the horizontal voltage level VL40 is inserted during the two inversion periods in each of the driving sections D40 and D41. The other driving sections D42˜D45 in FIG. 7 are still changed between the upper threshold voltage level VTH40 and the lower threshold voltage level VTH41 and have the same waveform as the driving sections D42˜D45 in FIG. 4. According to FIG. 7, the waveforms of the driving sections D40 and D41 are enlarged from the waveforms of the driving sections D42˜D45.

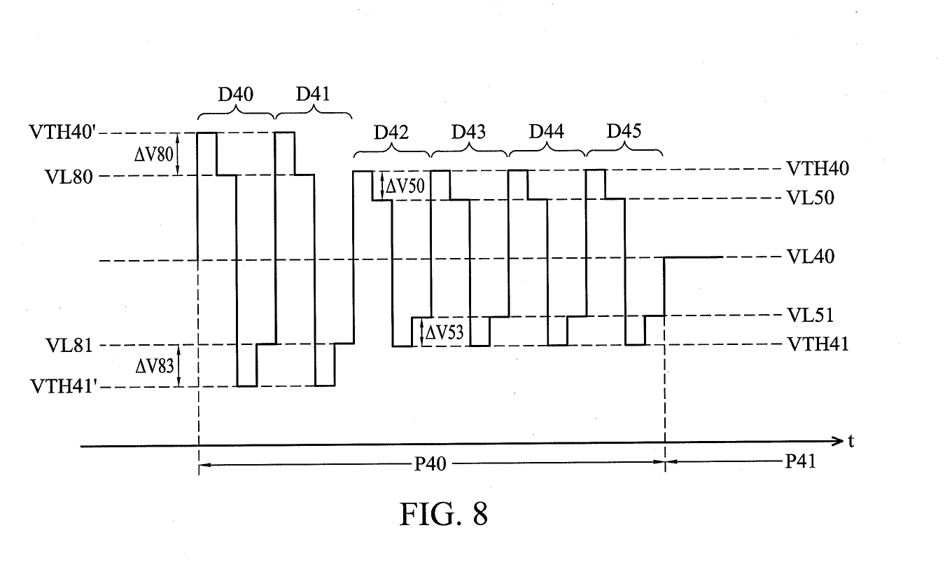

In another embodiment related to FIG. 5, as shown in FIG. 8, the driving sections D40 and D41 are changed between the upper threshold voltage level VTH40′ and the lower threshold voltage level VTH40′, and two horizontal voltage levels VL80 and VL81 between the upper threshold voltage level VTH40′ and the lower threshold voltage level VTH41′ are inserted during the two inversion periods in each of the driving sections D40 and D41, respectively. The other driving sections D42˜D45 in FIG. 8 are still changed between the upper threshold voltage level VTH40 and the lower threshold voltage level VTH41 and have the same waveform as the driving sections D42˜D45 in FIG. 5. In FIG. 8, the difference ΔV80 between the upper threshold voltage level VTH40′ and the horizontal voltage levels VL80 is greater than the difference ΔV50, and the difference ΔV83 between the horizontal voltage levels VL81 and the lower threshold voltage level VTH41′ and is greater than the different ΔV53. In a preferred embodiment, the difference ΔV80 is equal to the difference ΔV50, and the difference ΔV83 is equal to the different ΔV53. According to the above preferred embodiment, the difference ΔV80 may be further equal to the difference ΔV83. According to FIG. 8, the waveforms of the driving sections D40 and D41 are enlarged from the waveforms of the driving sections D42˜D45.

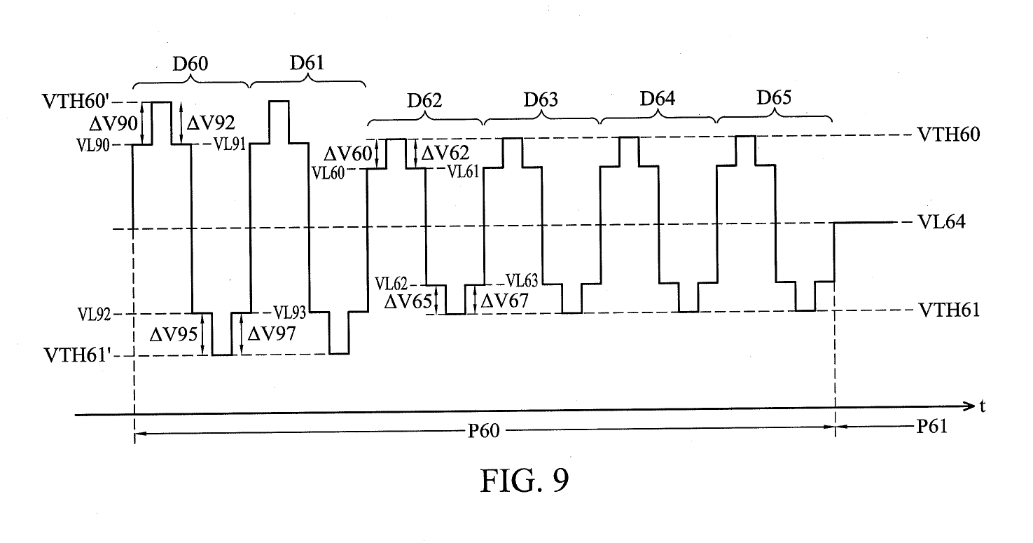

Moreover, according to the above embodiments of FIGS. 6A-6C, in each time period P60 of the driving signal S30′, each of the six driving sections D60˜D65 are changed between the upper threshold voltage level VTH60 and the lower threshold voltage level VTH61. In other embodiments, for over-driving, among the six driving sections D60˜D65 in each time period P60, at lease one earliest driving section is changed between an upper threshold voltage level VTH60′ and a lower threshold voltage level VTH61′. The difference between the upper threshold voltage level VTH60′ and the lower threshold voltage level VTH61′ is larger than the difference between the upper threshold voltage level VTH60 and the lower threshold voltage level VTH61, as shown in FIG. 9. In a preferred embodiment, the upper threshold voltage level VTH60′ is further higher than the upper threshold voltage level VTH60, while the lower threshold voltage level VTH61′ is further lower than the lower threshold voltage level VTH60.

For example, as shown in FIG. 9, the driving sections D60 and D61 are changed between the upper threshold voltage level VTH60′ and the lower threshold voltage level VTH60′. Before and after each of the driving sections D60 and D61 reaches the upper threshold voltage level VTH60′, two horizontal voltage levels VL90 and VL91 between the upper threshold voltage level VTH60′ and the lower threshold voltage level VTH61′ are inserted into the corresponding driving section, respectively. Similarly, before and after each of the driving sections D60 and D61 reaches the lower threshold voltage level VTH61′, two horizontal voltage levels VL92 and VL93 between the upper threshold voltage level VTH60′ and the lower threshold voltage level VTH61′ are inserted into the corresponding, respectively. The other driving sections D62˜D65 in FIG. 9 are still changed between the upper threshold voltage level VTH60 and the lower threshold voltage level VTH61 and have the same waveform as the driving sections D62˜D65 in FIG. 6B. In FIG. 9, the difference ΔV90 between the upper threshold voltage level VTH60′ and the horizontal voltage levels VL90 is greater than the difference ΔV60, the difference ΔV92 between the upper threshold voltage level VTH60′ and the horizontal voltage levels VL91 is greater than the difference ΔV62, the difference ΔV95 between the horizontal voltage levels VL92 and the lower threshold voltage level VTH61′ is greater than the different ΔV65, and the difference ΔV97 between the horizontal voltage levels VL93 and the lower threshold voltage level VTH61′ is greater than the different ΔV67. In a preferred embodiment, the difference ΔV90 between the upper threshold voltage level VTH60′ and the horizontal voltage levels VL90 is equal to the difference ΔV60, the difference ΔV92 between the upper threshold voltage level VTH60′ and the horizontal voltage levels VL91 is equal to the difference ΔV62, the difference ΔV95 between the horizontal voltage levels VL92 and the lower threshold voltage level VTH61′ is equal to the different ΔV65, and the difference ΔV97 between the horizontal voltage levels VL93 and the lower threshold voltage level VTH61′ is equal to the different ΔV67. In another preferred embodiment, the difference ΔV90 is equal to the difference ΔV95, and the difference ΔV92 is equal to the difference ΔV97. Based on the above preferred embodiment, the differences ΔV90, ΔV92, ΔV95, ΔV97 may be further equal. According to FIG. 9, the waveforms of the driving sections D60 and D61 are enlarged from the waveforms of the driving sections D62˜D65.

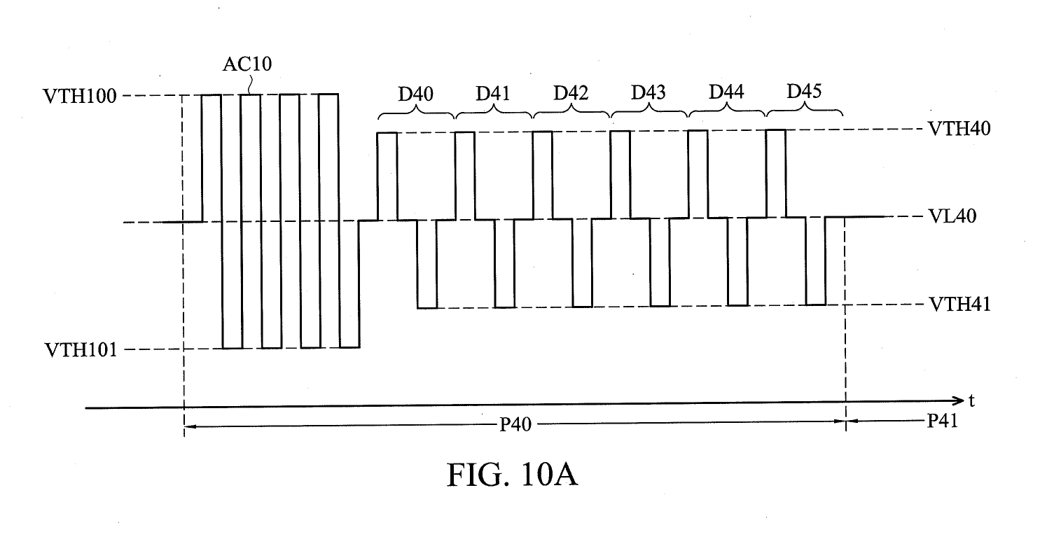

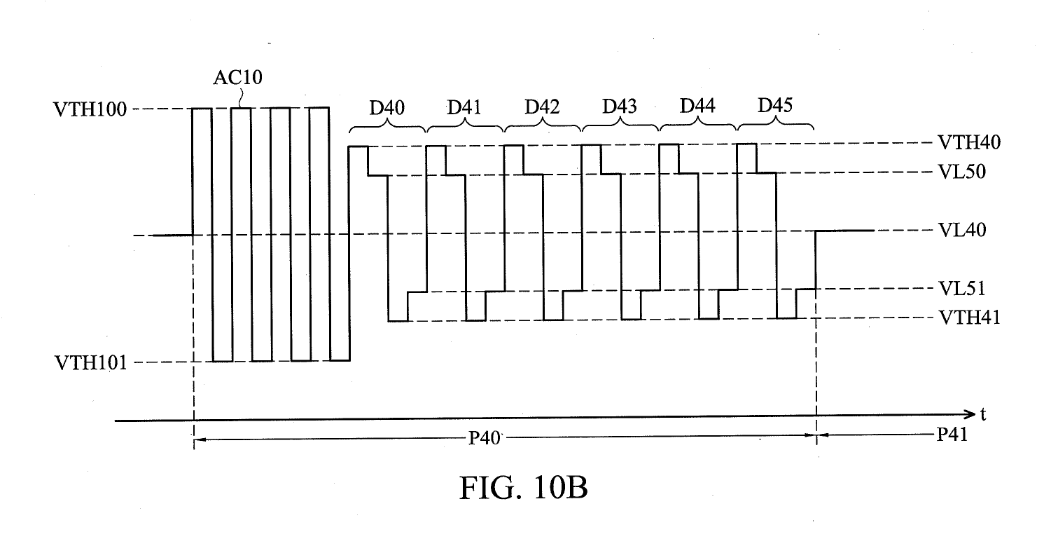

In another embodiments, to achieve not only over-driving but also rapid response of the medium 34, as shown in FIGS. 10A and 10B, an alternating-current (AC) component AC10 occurs before the driving section D40 in each time period P40 of the driving signal S30 of FIGS. 4B and 5. For clear description, FIGS. 10A and 10B show only one time period P40. The AC component AC 10 is changed between an upper threshold voltage level VTH100 and a lower threshold voltage level VTH101. However, no horizontal voltage level is inserted into the AC component AC 10. In the embodiment, the difference between the upper threshold voltage level VTH100 and the lower threshold voltage level VTH101 is larger than the difference between the upper threshold voltage level VTH40 and the lower threshold voltage level VTH41. In a preferred embodiment, the upper threshold voltage level VTH100 is further higher than the upper threshold voltage level VTH40, while the lower threshold voltage level VTH101 is further lower than the lower threshold voltage level VTH40. In the embodiments of FIGS. 10A and 10B, the number of driving sections in each time period P40 may be decreased.

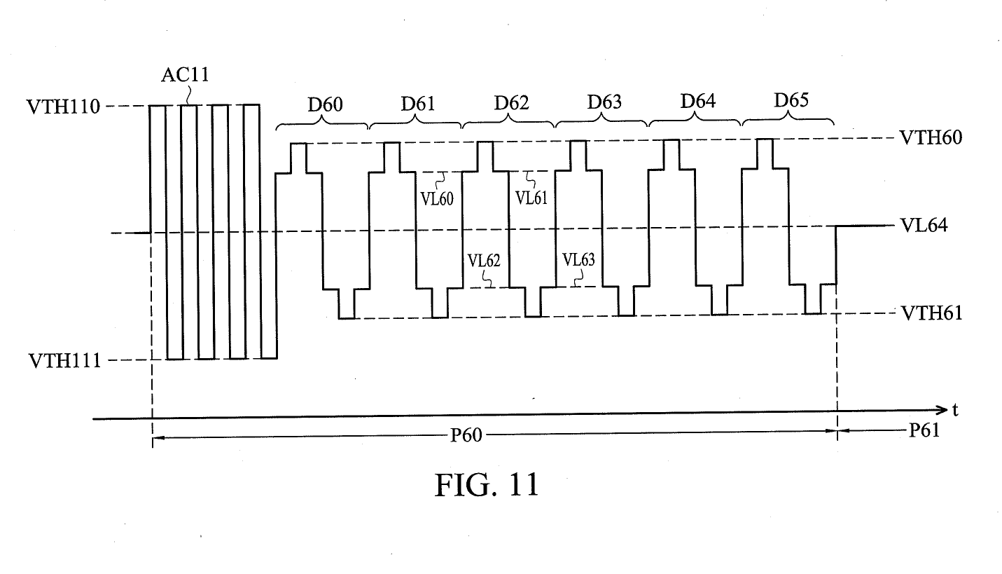

Similarly, in another embodiment, as shown in FIGS. 11, an AC component AC 11 occurs before the driving section D60 in each time period P60 of the driving signal S30 of FIG. 6B. The AC component AC11 is changed between an upper threshold voltage level VTH110 and a lower threshold voltage level VTH111. However, no horizontal voltage level is inserted into the AC component AC11. In the embodiment, the difference between the upper threshold voltage level VTH110 and the lower threshold voltage level VTH111 is larger than the difference between the upper threshold voltage level VTH60 and the lower threshold voltage level VTH61. In a preferred embodiment, the upper threshold voltage level VTH110 is further higher than the upper threshold voltage level VTH60, while the lower threshold voltage level VTH111 is further lower than the lower threshold voltage level VTH60. In the embodiment of FIG. 11, the number of driving sections in each time period P60 may be decreased.

In the above embodiments, the driving signal S30/S30′ is applied to the top-electrode 32B, while a fixed voltage is applied to the bottom electrode 32A is applied. In other embodiments, the bottom electrode 32A may be applied by an AC signal. Accordingly, there is a difference between the driving signal S30/S30′ and the AC signal in the time periods P40/P60. In some embodiments, the waveform of the AC signal is the same as the waveform of the driving signal S30/S30′, and, however, the AC signal is delayed from the driving signal by a predetermine time period, so that there is difference between the driving signal S30/S30′ and the AC signal in the time periods P40/P60 to deform the medium 34.

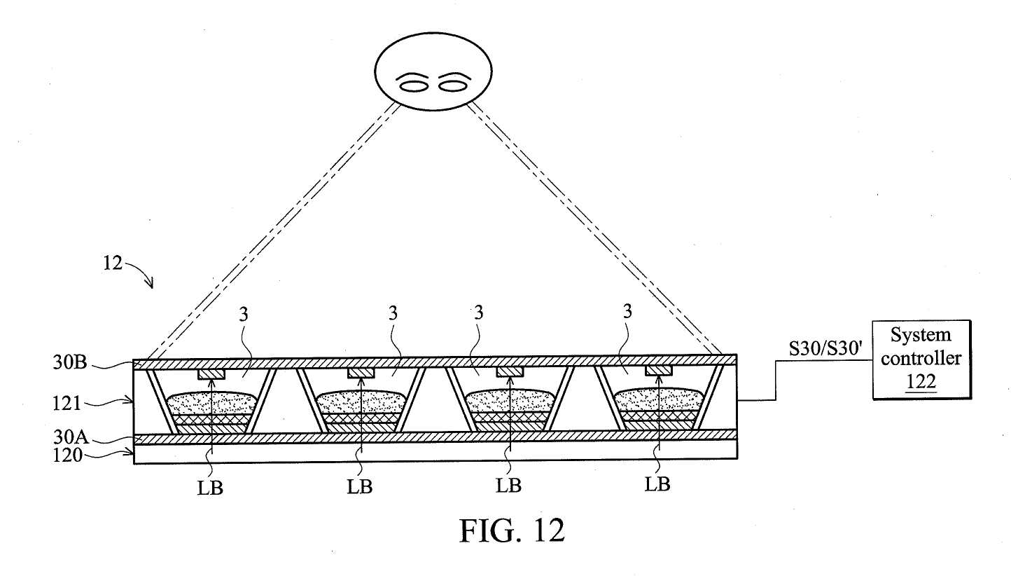

As the above description, the medium 34 is deformed in accordance with the electric potential difference between the bottom electrode 32A and the top electrode 32B. Thus, deflection angles of light beams entering the electrowetting cell 3 are changed. In some embodiments, the electrowetting cell 3 may be applied to a three-dimensional (3D) display system capable of showing stereoscopic images or animations. By changing deflection angles of light beams entering the electrowetting cell 3, right eye images are deflected to a right eye of a viewer, and left eye images are deflected to a left eye of the viewer, respectively, so that the viewer may view 3D images. As shown in FIG. 12, a 3D display system 12 includes a display device 120, a light modulating device 21, and a system controller 122. The light modulating device 121 is composed of a plurality of electrowetting cells 3 of FIG. 3, which may deflect directions of light beams LB coming from the display device 120 and traveling therethrough. The display device 120 is collocated with the light modulating device 121, and each of electrowetting cells 3 corresponds to at least one pixel of the display device 120. The light beams of the images from the display device 120 are deflected by the light modulating device 121 to form 3D images. The system controller 122 may serve as or include the driving device 4 of FIG. 4 to provide the driving signal S30/S30′. In the embodiment of FIG. 12, the plurality of the electrowetting cells 3 share one substrate 30A and one opposite substrate 30B.

The display device 120 can be an electronic paper, an electronic reader, an electroluminescent display (ELD), a organic electroluminescent display (OELD), a vacuum fluorescent display (VFD), a light emitting diode display (LED), a cathode ray tube (CRT), a liquid crystal display (LCD), a plasma display panel (PDP), a digital light processing (DLP) display, a Liquid crystal on silicon (LCoS), an organic light-emitting diode (OLED), a surface-conduction electron-emitter display (SED), a field emission display (FED), a laser TV (Quantum dot laser; Liquid crystal laser), a ferro liquid display (FLD), an interferometric modulator display (iMoD), a thick-film dielectric electroluminescent (TDEL), a quantum dot display (QD-LED), a telescopic pixel display (TPD), an organic light-emitting transistor (OLET), an electrochromic display, a laser phosphor display (LPD), or the like.

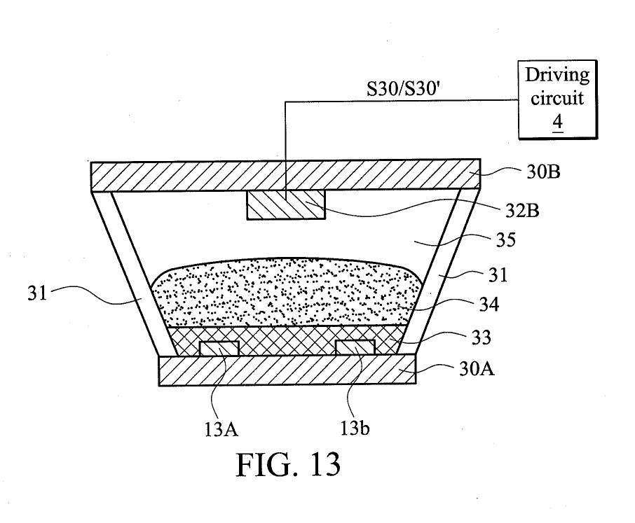

In the embodiment of FIG. 3, the structure of the electrowetting cell 3 is an example, and there is one bottom electrode 32A disposed on the substrate 30A. In some embodiments, there are two bottom electrodes in an electrowetting cell. As shown in FIG. 13, expect the bottom electrode, the structure of the electrowetting cell 3′ is same as the structure of the electrowetting cell 3 of FIG. 3. Two bottom electrodes 13A and 13B are disposed in the dielectric layer 33. The bottom electrodes 13A and 13B may be applied by different voltages from the driving device 4. In accordance with electric potential difference between the bottom electrode 13A and the top electrode 32B and between the bottom electrode 13B and the top electrode 32B, the medium 34 is deformed.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. An electrowetting cell comprising:
a first substrate;
a spacer disposed on the first substrate;
a second substrate disposed on the spacer and opposite to the first substrate, wherein the first substrate, the second substrate and the spacer define a compartment;
a first electrode disposed on the first substrate;
a second electrode disposed on the second substrate;
a dielectric layer formed on the first electrode; and
a medium filled in the compartment, and deformed in accordance with an electric potential difference between the first and second electrodes,
wherein one of the first and second electrodes is applied by a driving signal, the driving signal is generates in a first time period and a second time period, and the driving signal is divided into a plurality of driving sections in the first time period,
wherein a first driving section among the plurality of driving sections is changed between a first threshold voltage level and a second threshold voltage level,
wherein when the first driving section changes from the first threshold voltage level to the second threshold voltage level, a first horizontal voltage level between the first and second threshold voltage levels is inserted into the first driving section, and
wherein when the first driving section changes from the second threshold voltage level to the first threshold voltage level, a second horizontal voltage level between the first and second threshold voltage levels is inserted into the first driving section.

2. The electrowetting cell as claimed in claim 1, wherein, for the first driving section, the first threshold voltage level occurs in a first time period, the second threshold voltage level occurs in a second time period later than the first time period, and the first horizontal voltage level occurs in a third time period between the first and second time periods following the first time period.

3. The electrowetting cell as claimed in claim 2, wherein the second horizontal voltage level occurs in a fourth time period following the second time period.

4. The electrowetting cell as claimed in claim 3, wherein, for the first driving section, each of the first and second horizontal voltage levels is an average voltage level between the first and second threshold voltage levels.

5. The electrowetting cell as claimed in claim 3, wherein, for the first driving section, a difference between the first threshold voltage level and the first horizontal voltage level is less than a difference between the first horizontal voltage level and the second threshold voltage level, and a difference between the first threshold voltage level and the second horizontal voltage level is larger than a different between the second horizontal voltage level and the second threshold voltage level.

6. The electrowetting cell as claimed in claim 3, wherein a third horizontal voltage level between the first and second threshold voltage levels is inserted into the first driving section in a fifth time period earlier than the first time period, and a fourth horizontal voltage level between the first horizontal voltage level and the second threshold voltage level is inserted into the first driving section in a sixth time period between the third time period and the second time period.

7. The electrowetting cell as claimed in claim 6, wherein for the first driving section, a difference between the first threshold voltage level and the third horizontal voltage level is less than a difference between the third horizontal voltage level and the second threshold voltage level, and a difference between the first threshold voltage level and the first horizontal voltage level is less than a different between the first horizontal voltage level and the second threshold voltage level, and
wherein, for the first driving section, a difference between the first threshold voltage level and the fourth horizontal voltage level is larger than a difference between the fourth horizontal voltage level and the second threshold voltage level, and a difference between the first threshold voltage level and the second horizontal voltage level is larger than a different between the second horizontal voltage level and the second threshold voltage level.

8. The electrowetting cell as claimed in claim 7, wherein, for the first driving section, the difference between the first threshold voltage level and the third horizontal voltage level is equal to the difference between the fourth horizontal voltage level and the second threshold voltage level, and
wherein, for the first driving section, the difference between the first threshold voltage level and the first horizontal voltage level is equal to the difference between the second horizontal voltage level and the second threshold voltage level.

9. The electrowetting cell as claimed in claim 1, wherein a second driving section among the plurality of driving sections is changed between a third threshold voltage level and a fourth threshold voltage level, and a different between the third and the fourth threshold voltage levels is larger than a different between the first and second threshold voltage levels.

10. The electrowetting cell as claimed in claim 9, wherein a second horizontal voltage level between the third and fourth threshold voltage levels is inserted into the second driving section.

11. The electrowetting cell as claimed in claim 1, wherein one of the first and second electrodes is applied by the driving signal, and the other of the first and second electrodes is applied by a fixed voltage.

12. The electrowetting cell as claimed in claim 1, wherein one of the first and second electrodes is applied by the driving signal, and the other of the first and second electrodes is applied by an alternating-current signal.

13. The electrowetting cell as claimed in claim 12, wherein a waveform of the alternating-current signal is the same as a waveform of the driving signal, and the alternating-current signal is delayed from the driving signal by a predetermine time period.

14. The electrowetting cell as claimed in claim 1, wherein the driving signal is continuously at a predetermined voltage level in the second time period.

15. The electrowetting cell as claimed in claim 1, wherein the driving signal comprises an alternating-current component occurs before the plurality of driving sections in the first time period, the alternating-current component is changed between a third threshold voltage level and a fourth threshold voltage level, and a different between the third and the fourth threshold voltage levels is larger than a different between the first and second threshold voltage levels.

16. A driving method for an electrowetting cell, wherein the electrowetting cell comprises a first substrate, a spacer disposed on the first substrate, a second substrate disposed on the spacer and opposite to the first substrate, a first electrode disposed on the first substrate, a second electrode disposed on the second substrate, a dielectric layer formed on the first electrode, and a medium filled in a compartment defined by the first substrate, the second substrate and the spacer, and the driving method comprises:
providing a driving signal in a first time period and a second time period wherein the driving signal comprises a plurality of driving sections; and
applying the driving signal to one of the first and second electrode to deform the medium, wherein a first driving section among the plurality of driving sections is changed between a first threshold voltage level and a second threshold voltage level,
inserting a first horizontal voltage level between the first and second threshold voltage levels into the first driving section when the first driving section changes from the first threshold voltage level to the second threshold voltage level, and
inserting a second horizontal voltage level between the first and second threshold voltage levels into the first driving section when the first driving section changes from the second threshold voltage level to the first threshold voltage level.

17. The driving method as claimed in claim 15, wherein, for the first driving section, the first threshold voltage level occurs in a first time period, the second threshold voltage level occurs in a second time period later than the first time period, and the step of generating the driving signal comprises:
inserting the first horizontal voltage level into the first driving section in a third time period following the first time period.

18. The driving method as claimed in claim 17, wherein:
a second horizontal voltage level is inserted into the first driving section in a fourth time period following the second time period.

19. The driving method as claimed in claim 18, wherein, for the first driving section, each of the first and second horizontal voltage levels is an average voltage level between the first and second threshold voltage levels.

20. The driving method as claimed in claim 18, wherein, for the first driving section, a difference between the first threshold voltage level and the first horizontal voltage level is less than a difference between the first horizontal voltage level and the second threshold voltage level, and a difference between the first threshold voltage level and the second horizontal voltage level is larger than a different between the second horizontal voltage level and the second threshold voltage level.

21. The driving method as claimed in claim 18, wherein the step of generating the driving signal comprises:
inserting a third horizontal voltage level between the first and second threshold voltage levels inserted into the first driving section in a fifth time period earlier than the first time period, and
inserting a fourth horizontal voltage level between the first horizontal voltage level and the second threshold voltage level into the first driving section in a sixth time period between the third time period and the second time period.

22. The driving method as claimed in claim 21, wherein for the first driving section, a difference between the first threshold voltage level and the third horizontal voltage level is less than a difference between the third horizontal voltage level and the second threshold voltage level, and a difference between the first threshold voltage level and the first horizontal voltage level is less than a different between the first horizontal voltage level and the second threshold voltage level, and
wherein, for the first driving section, a difference between the first threshold voltage level and the fourth horizontal voltage level is larger than a difference between the fourth horizontal voltage level and the second threshold voltage level, and a difference between the first threshold voltage level and the second horizontal voltage level is larger than a different between the second horizontal voltage level and the second threshold voltage level.

23. The driving method as claimed in claim 22, wherein, for the first driving section, the difference between the first threshold voltage level and the third horizontal voltage level is equal to the difference between the fourth horizontal voltage level and the second threshold voltage level, and
wherein, for the first driving section, the difference between the first threshold voltage level and the first horizontal voltage level is equal to the difference between the second horizontal voltage level and the second threshold voltage level.

24. The driving method as claimed in claim 16, wherein a second driving section among the plurality of driving sections is changed between a third threshold voltage level and a fourth threshold voltage level, and a different between the third and the fourth threshold voltage levels is larger than a different between the first and second threshold voltage levels.

25. The driving method as claimed in claim 24, wherein the step of generating the driving signal comprises:
inserting a second horizontal voltage level between the third and fourth threshold voltage levels into the second driving section.

26. The driving method as claimed in claim 16 further comprising applying a fixed voltage to the other of the first and second electrodes.

27. The driving method as claimed in claim 16 further comprising applying an alternating-current signal to the other of the first and second electrodes.

28. The driving method cell as claimed in claim 27, wherein a waveform of the alternating-current signal is the same as a waveform of the driving signal, and the alternating-current signal is delayed from the driving signal by a predetermine time period.

29. The driving method as claimed in claim 16, wherein the driving signal is continuously at a predetermined voltage level in the second time period.

30. The driving method as claimed in claim 16, wherein the driving signal comprises an alternating-current component occurs before the plurality of driving sections in the first time period, the alternating-current component is changed between a third threshold voltage level and a fourth threshold voltage level, and a different between the third and the fourth threshold voltage levels is larger than a different between the first and second threshold voltage levels.
